(19) United States
(12) Patent Application Publication
(10) Pub. No.: US 2026/0364976 A1
(43) Pub. Date: Nov. 19, 2026

(54) TIRE AND TIRE MOLD

(71) Applicants: The Yokohama Rubber Co., LTD., Kanagawa (JP); YOKOHAMA MOLD CO., LTD., Ibaraki (JP)

(72) Inventors: Noboru TAKADA, Ibaraki (JP); Hiroshi FURUSAWA, Kanagawa (JP)

(21) Appl. No.: 19/135,274

(22) PCT Filed: Nov. 2, 2023
(86) PCT No.: PCT/JP2023/039635

§ 371 Date: Jun. 3, 2025

(30) Foreign Application Priority Data
Dec. 8, 2022 (JP) 2022-196215

(51) Int. Cl. B60C 13/00; B29D 30/72

(52) U.S. Cl. CPC B60C 13/001; B29D 30/72; B29D 2030/726

(57) ABSTRACT

A tire includes: in a sidewall portion, a marking portion and a background portion surrounding the marking portion; and a serration formed in any one of the marking portion and the background portion, the serration including a plurality of ridges arranged side by side. In the tire, each ridge has, in a cross section orthogonal to a length direction of the ridge, a first and a second sidewall surfaces having 0° or a negative gradient with respect to a normal line of a reference plane on which the ridge is formed, a first top surface inclined to one side with respect to the reference plane, and a second top surface inclined to the other side with respect to the reference plane, and the first top surface and the second top surface are connected to each other and form a recess.

### TECHNICAL FIELD

The present technology relates to a tire including a serration formed in a sidewall portion and a tire mold for molding the tire and relates particularly to a tire and a tire mold that can provide an enhanced visual effect of light and dark based on the serration and exhibit excellent visibility.

### BACKGROUND ART

A proposed tire in which a marking portion composed of an alphanumeric, a pattern, a symbol, or the like and a background portion surrounding the marking portion are formed in a sidewall portion of the tire and a serration including a plurality of ridges arranged side by side is formed in any one of the marking portion and the background portion (see, for example, Japan Unexamined Patent Publication Nos. 2003-175707 A, 2019-147495 A, and 2020-6863 A). Providing such a serration in the sidewall portion can enhance the visibility of the marking portion by the visual effect of light and dark based on the serration.

However, although a high ridge is desirably formed to enhance the visual effect of light and dark, the height of the ridge is limited in the sidewall portion of the tire. Thus, there is a limit to the effect of improving visibility based on the height of the ridge. For example, in the case where the ridge has a triangular cross-sectional shape including a vertical surface orthogonal to a surface of the sidewall portion and an inclined surface, reflection of light is biased in one direction, and sufficient visibility may not be obtained depending on a viewpoint.

### SUMMARY

The present technology provides a tire and a tire mold that can provide an enhanced visual effect of light and dark based on a serration and exhibit excellent visibility.

A tire according to an embodiment of the present technology includes: in a sidewall portion, a marking portion and a background portion surrounding the marking portion; and a serration formed in any one of the marking portion and the background portion, the serration including a plurality of ridges arranged side by side.

In the tire, each ridge of the ridges has, in a cross section orthogonal to a length direction of the ridge, a first and a second sidewall surfaces having 0° or a negative gradient with respect to a normal line of a reference plane on which the ridge is formed, a first top surface inclined to one side with respect to the reference plane, and a second top surface inclined to the other side with respect to the reference plane, and the first top surface and the second top surface are connected to each other and form a recess.

A tire mold according to an embodiment of the present technology is a tire mold for molding the above-described tire and includes a molding surface having a shape corresponding to the marking portion, the background portion, and the serration.

In the present technology, each ridge has the first and the second sidewall surfaces having 0° or a negative gradient with respect to the normal line of the reference plane. This easily forms a shadow along the ridges and effectively absorbs light between the ridges. Each ridge has the first top surface inclined to one side with respect to the reference plane and the second top surface inclined to the other side with respect to the reference plane, and the first and the second top surfaces are connected to each other and form a recess. This causes the first and the second top surfaces to effectively reflect light. Therefore, the structure of the ridge can enhance the visual effect of light and dark. In addition, when light is reflected by the first and the second top surfaces, the same visual effect can be obtained when viewed from one direction side or the other direction side with respect to the front of the ridge, and the deviation of the visual effect can be reduced. This can enhance the visual effect of light and dark based on the serration while allowing the height of the ridge to be kept low and exhibit excellent visibility.

In the present technology, each ridge preferably has a symmetrical shape in a cross section orthogonal to the length direction of the ridge. Making the cross-sectional shape of the ridge left-right symmetry in this manner can effectively reduce the bias of the visual effect.

Angles α of the first and the second sidewall surfaces with respect to the normal line of the reference plane are each preferably in a range −25°≤α<0°. Setting the angles α of the first and second sidewall surfaces in the above-described range can enhance the visual effect of light and dark.

An apex angle β of the ridge in a cross section orthogonal to the length direction of the ridge is preferably in a range 30°≤β≤60°. Setting the apex angle of the ridge in the above range can enhance the visual effect of light and dark.

A pitch of the ridge preferably ranges from 0.5 mm to 1.2 mm, and a height of the ridge preferably ranges from 0.2 mm to 0.5 mm. The ridge having the above-described cross-sectional shape is excellent in visibility. Therefore, the pitch of the ridge can be increased, and the height of the ridge can be reduced.

A gap between the adjacent ridges is preferably wider toward the reference plane side of the ridge, and a bottom surface between the adjacent ridges preferably has a flat shape or a V-shape in a cross section orthogonal to the length direction of the ridge. Widening the gap between the adjacent ridges toward the reference plane side of the ridge and forming the bottom surface into a flat shape or a V-shape can reduce the reflection of light entering between the adjacent ridges and enhance the visual effect of light and dark.

The ridge preferably includes a chamfered portion composed of a flat surface or a curved surface between the first top surface and the first sidewall surface and between the second top surface and the second sidewall surface. When such a chamfered portion is provided, the direction of absorption or reflection of light changes. This can have variations in the visual effect of light and dark.

The tire according to an embodiment of the present technology may be a pneumatic tire or may be a non-pneumatic tire. In a case of a pneumatic tire, the interior thereof can be filled with any gas including air and inert gas such as nitrogen. Non-pneumatic tires include solid tires.

### BRIEF DESCRIPTION OF DRAWINGS

FIG. 1 is a meridian cross-sectional view illustrating a pneumatic tire according to an embodiment of the present technology.

FIG. 2 is a plan view illustrating a marking portion and a background portion formed in a sidewall portion, and a serration formed in the marking portion.

FIG. 3 is a cross-sectional view taken along the line III-III of FIG. 2.

FIG. 4 is a cross-sectional view of FIG. 3 with dimension lines added.

FIG. 5 is a plan view illustrating the marking portion and the background portion formed in the sidewall portion and the serration formed in the background portion.

FIG. 6 is a cross-sectional view illustrating an example of a reflection state of light in the sidewall portion.

FIG. 7 is a cross-sectional view illustrating a modified example of the serration.

FIG. 8 is a cross-sectional view illustrating another modified example of the serration.

FIG. 9 is a cross-sectional view illustrating another modified example of the serration.

FIG. 10 is a cross-sectional view illustrating another modified example of the serration.

FIG. 11 is a cross-sectional view illustrating one example of a tire mold of an embodiment of the present technology.

### DETAILED DESCRIPTION

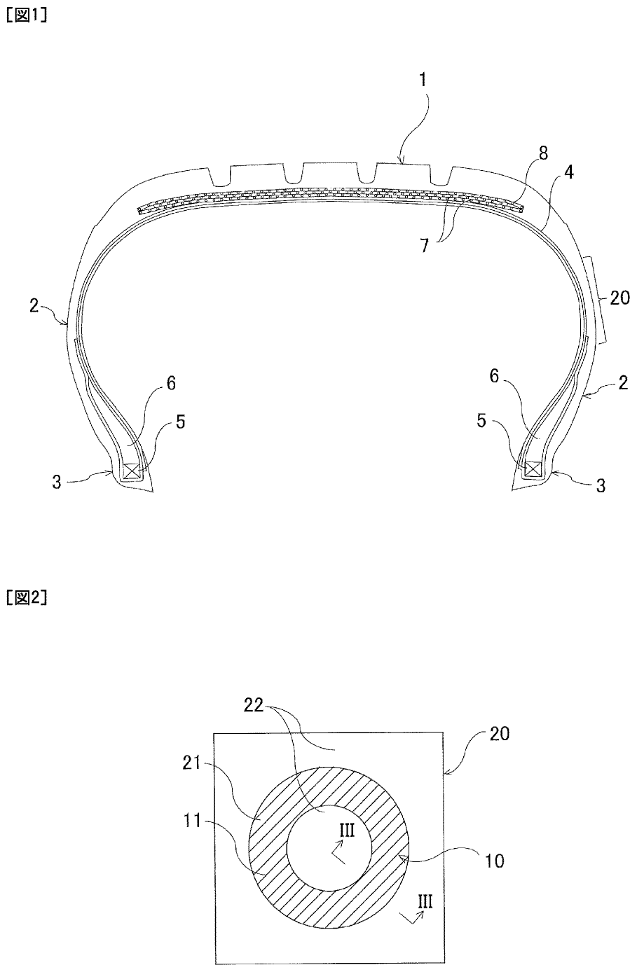

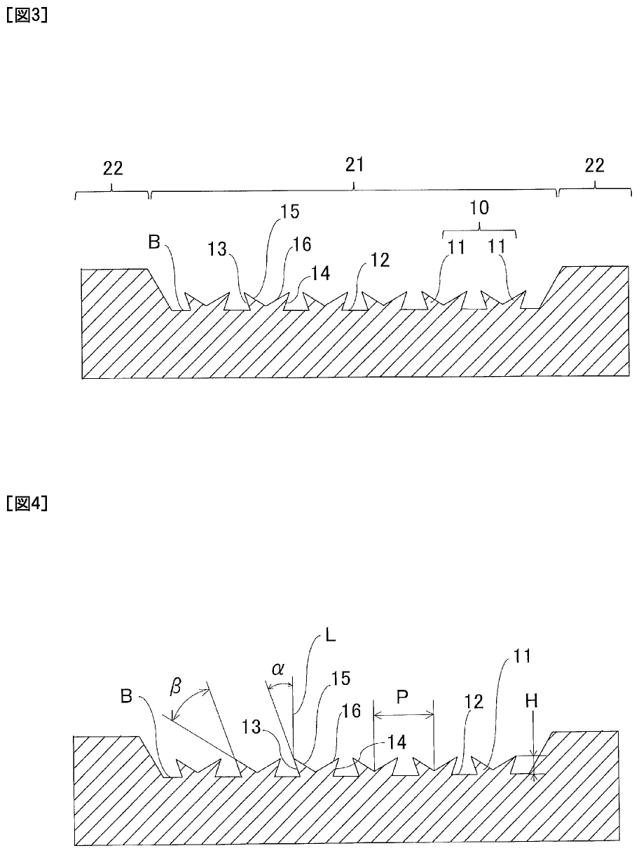

Configurations of embodiments of the present technology will be described in detail below with reference to the accompanying drawings. FIG. 1 illustrates a pneumatic tire according to an embodiment of the present technology, and FIGS. 2 to 4 illustrate the main portion of the pneumatic tire.

As illustrated in FIG. 1, a pneumatic tire of the present embodiment includes a tread portion 1 extending in a tire circumferential direction and having an annular shape, a pair of sidewall portions 2, 2 disposed on both sides of the tread portion 1, and a pair of bead portions 3, 3 disposed on inner sides of the sidewall portions 2, 2 in a tire radial direction.

A carcass layer 4 is mounted between the pair of bead portions 3, 3. The carcass layer 4 includes a plurality of reinforcing cords extending in the tire radial direction and is folded back around a bead core 5 disposed in each of the bead portions 3 from a tire inner side to a tire outer side. A bead filler 6 having a triangular cross-sectional shape and composed of a rubber composition is disposed on the outer circumference of the bead core 5.

On the other hand, a plurality of belt layers 7 is embedded on the outer circumferential side of the carcass layer 4 in the tread portion 1. The belt layers 7 include a plurality of reinforcing cords that are inclined with respect to the tire circumferential direction, and the reinforcing cords are disposed so as to intersect each other between the layers. In the belt layers 7, the inclination angle of the reinforcing cords with respect to the tire circumferential direction is set to fall in a range from 10° to 40°, for example. Steel cords are preferably used as the reinforcing cords of the belt layers 7. To improve high-speed durability, at least one belt cover layer 8 formed by arranging reinforcing cords at an angle of, for example, 5° or less with respect to the tire circumferential direction is disposed on an outer circumferential side of the belt layers 7. Organic fiber cords such as nylon and aramid are preferably used as the reinforcing cords of the belt cover layer 8.

Note that the tire internal structure described above represents a typical example of a pneumatic tire, but the pneumatic tire is not limited thereto. Various grooves such as a main groove extending in the tire circumferential direction and a lug groove extending in the tire width direction are formed in the tread portion 1.

As illustrated in FIG. 2, a decorative portion 20 is formed in the sidewall portion 2. The decorative portion 20 includes a marking portion 21 and a background portion 22 surrounding the marking portion 21. The marking portion 21 forms an alphanumeric, a pattern, a symbol, or the like and is recessed from the background portion 22. Then, the marking portion 21 is formed with a serration 10 including a plurality of ridges 11 arranged side by side. The ridge 11 is a protrusion protruding from a reference plane B, and the serration 10 is an aggregate of the ridges 11. The background portion 22 may have a structure recessed from the marking portion 21, and the serration 10 including a plurality of ridges 11 arranged side by side may be formed on the background portion 22 (see FIG. 5).

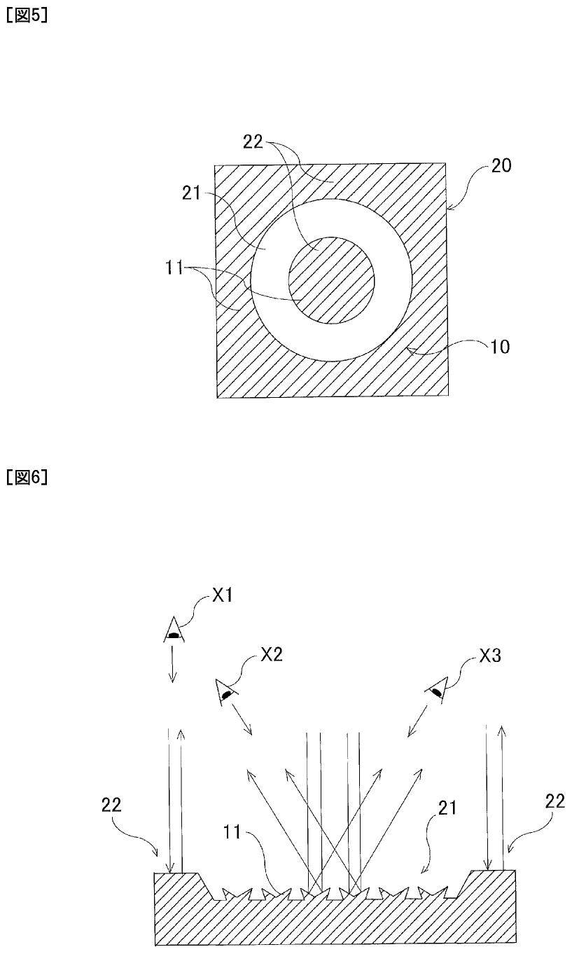

As illustrated in FIGS. 3 and 4, each ridge 11 has, in a cross section orthogonal to the length direction of the ridge 11, a first sidewall surface 13 and a second sidewall surface 14 having 0° or a negative gradient with respect to a normal line L of the reference plane B on which the ridge 11 is formed, a first top surface 15 inclined to one side with respect to the reference plane B, and a second top surface 16 inclined to the other side with respect to the reference plane B. The first top surface 15 and the second top surface 16 are connected to each other and form a recess. The reference plane B is a plane passing through base ends of the first sidewall surface 13 and the second sidewall surface 14 and coincides with a bottom surface 12 between the adjacent ridges 11, 11 in FIGS. 3 and 4. The ridge 11 (having a first sidewall surface 13 and a second sidewall surface 14) having a negative gradient with respect to the normal line L of the reference plane B means that a part of the ridge 11 has an undercut shape protruding above the bottom surface 12. A top surface of the background portion 22 is parallel to the reference plane B.

In the above-described tire, each ridge 11 having the first sidewall surface 13 and the second sidewall surface 14 having 0° or a negative gradient with respect to the normal line L of the reference plane B easily forms a shadow along the ridges 11 and effectively absorbs light between the ridges 11, 11. Each ridge 11 has the first top surface 15 inclined to one side with respect to the reference plane B and the second top surface 16 inclined to the other side with respect to the reference plane B, and the first top surface 15 and the second top surface 16 are connected to each other and form a recess. This causes the first top surface 15 and the second top surface 16 to effectively reflect light. Therefore, the structure of the ridge 11 can enhance the visual effect of light and dark. In addition, when light is reflected by the first top surface 15 and the second top surface 16, the same visual effect can be obtained when viewed from one direction side or the other direction side with respect to the front of the ridge 11, and the deviation of the visual effect can be reduced. This can enhance the visual effect of light and dark based on the serration 10 while allowing the height of the ridge 11 to be kept low and exhibit excellent visibility.

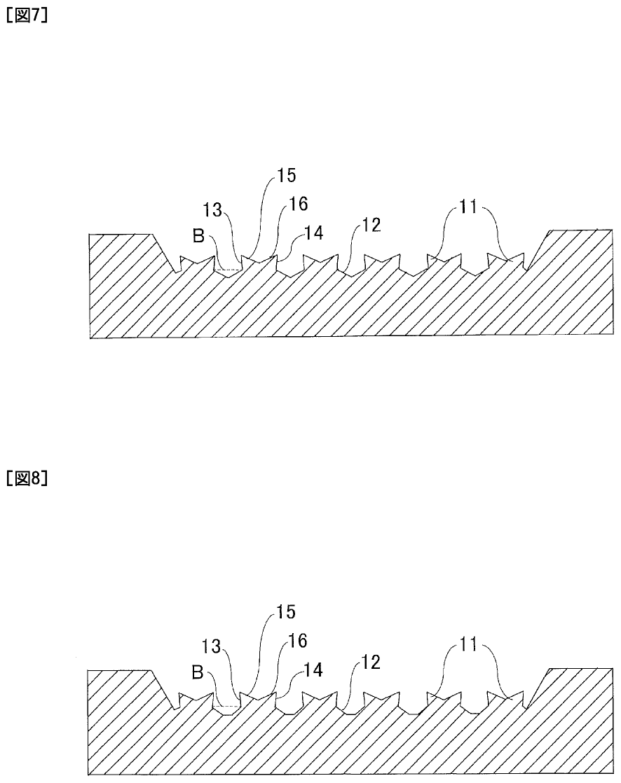

FIG. 6 illustrates an example of a reflection state of light in the sidewall portion. In FIG. 6, when it is assumed that light sources are located in front of the sidewall portion 2, the marking portion 21 appears black and the background portion 22 appears bright due to reflection of light in a viewing direction X1 in which the sidewall portion 2 is viewed from the front. In particular, since the ridge 11 has an undercut shape and the light entering between the ridges 11, 11 is hardly reflected, the blackening of the marking portion 21 is promoted. On the other hand, at a viewing position X2 in which the sidewall portion 2 is viewed obliquely from one direction side with respect to the front and at a viewing position X3 in which the sidewall portion 2 is viewed obliquely from the other direction side with respect to the front, the marking portion 21 appears bright due to reflection of light and the background portion 22 appears black. In addition, the same visual effect can be obtained at both the viewing positions X2 and X3.

In the tire described above, as illustrated in FIG. 4, each ridge 11 preferably has a symmetrical shape in a cross section orthogonal to the length direction of the ridge 11. Making the cross-sectional shape of the ridge 11 left-right symmetry in this manner makes the luminances due to the reflection of light when viewed from the left and right with respect to the front equivalent and can effectively reduce the bias of the visual effect.

In the tire described above, angles α of the first and the second sidewall surfaces 13, 14 with respect to the normal line L of the reference plane B are each preferably in the range −25°≤α<0°. The angles α mean an undercut shape when being negative values and mean a non-undercut shape when being positive values. Setting the angles α of the first and second sidewall surfaces 13, 14 to a negative gradient in the above-described range can enhance the visual effect of light and dark. Here, if the angles α of the first and second sidewall surfaces 13, 14 are greater than 0°, the effect of absorbing light decreases. In contrast, if the angles α are smaller than −25°, mold machining becomes difficult. In particular, the angles α of the first and second sidewall surfaces 13, 14 are each preferably in the range −5°≤α<−15°.

In the tire described above, an apex angle β of the ridge 11 in a cross section orthogonal to the length direction of the ridge 11 is preferably in the range 30°≤β≤60°. The apex angle β is an angle formed by the first top surface 15 and the first sidewall surface 13 or an angle formed by the second top surface 16 and the second sidewall surface 14 in a cross section orthogonal to the length direction of the ridge 11. Setting the apex angle β of the ridge 11 in the above range can appropriately disperse the reflection direction of light and enhance the visual effect of light and dark. If the apex angle β of the ridge 11 is out of the above range, the effect of appropriately dispersing the reflection direction of light is reduced.

In the tire described above, a pitch P of the ridge 11 preferably ranges from 0.5 mm to 1.2 mm, and a height H of the ridge 11 preferably ranges from 0.2 mm to 0.5 mm. The ridge 11 having the above-described cross-sectional shape is excellent in visibility. Therefore, the pitch P of the ridge 11 can be increased and the height H of the ridge 11 can be reduced. In particular, the pitch P of the ridge 11 preferably ranges from 0.6 mm to 0.8 mm, and the height H of the ridge 11 preferably ranges from 0.3 mm to 0.4 mm.

In the tire described above, the gap between the adjacent ridges 11, 11 is preferably wider toward the reference plane B side of the ridge 11, and the bottom surface 12 between the adjacent ridges 11, 11 preferably has, in the cross section orthogonal to the length direction of the ridge 11, a flat shape, a V-shape, or a shape with the flat shape and the V-shape combined. Widening the gap between the adjacent ridges 11, 11 toward the reference plane B side of the ridge 11 and forming the bottom surface 12 into a flat shape, a V-shape, or a shape with the flat shape and the V-shape combined can reduce the reflection of light entering between the adjacent ridges 11, 11 and enhance the visual effect of light and dark.

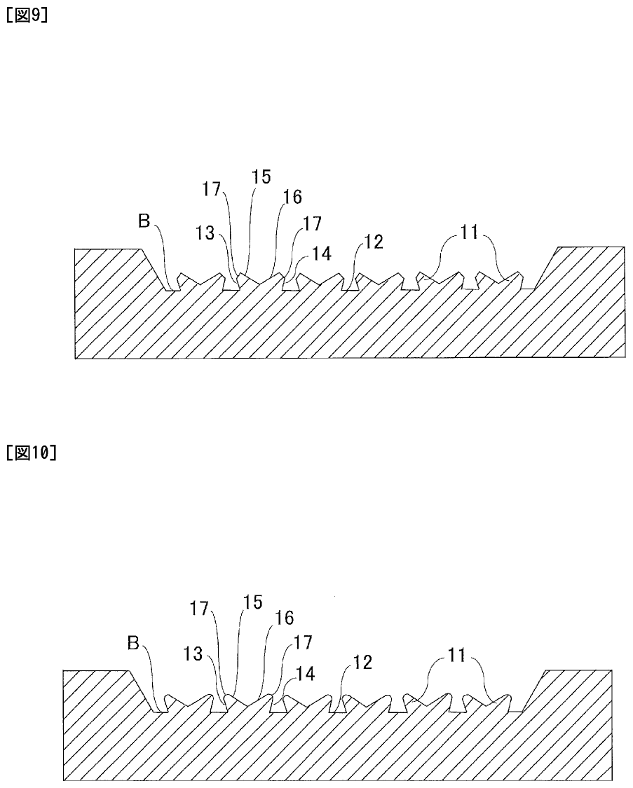

In the example of FIG. 3, the bottom surface 12 between the adjacent ridges 11, 11 has a flat shape. On the other hand, in the example of FIG. 7, the bottom surface 12 between the adjacent ridges 11, 11 has a V-shape. In the example of FIG. 8, the bottom surface 12 between the adjacent ridges 11, 11 has a shape with a flat shape and a V-shape combined. That is, in FIG. 8, the bottom surface 12 between the adjacent ridges 11, 11 has a flat surface and a pair of inclined surfaces located on both sides of the flat surface, and the flat surface has a most recessed shape. Such a shape can reduce reflection of light entering between the adjacent ridges 11, 11 to the outside. Since the reference plane B is a plane passing through the base ends of the first sidewall surface 13 and the second sidewall surface 14, the reference plane B does not coincide with the bottom surface 12 between the adjacent ridges 11, 11 in FIGS. 7 and 8.

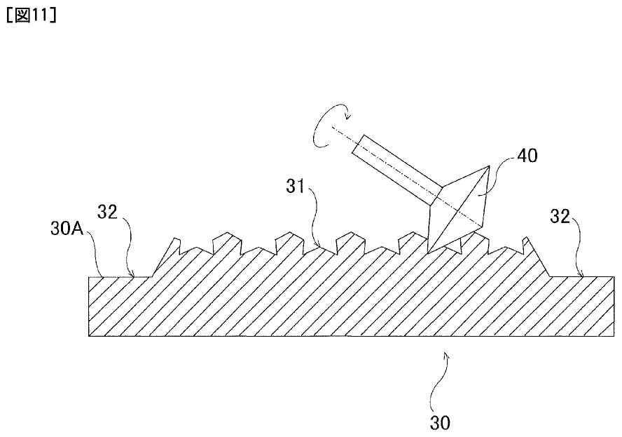

In the tire described above, as illustrated in FIGS. 9 and 10, the ridge 11 preferably includes a chamfered portion 17 composed of a flat surface or a curved surface between the first top surface 15 and the first sidewall surface 13 and between the second top surface 16 and the second sidewall surface 14. In the example of FIG. 9, the chamfered portion 17 composed of a flat surface is composed. In the example of FIG. 10, the chamfered portion 17 composed of a curved surface is composed. When such a chamfered portion 17 is provided, the direction of absorption or reflection of light changes. This can have variations in the visual effect of light and dark.

FIG. 11 illustrates one example of a tire mold of an embodiment of the present technology. In FIG. 11, only the main portion of a side plate 30 in which the sidewall portion 2 of the tire is molded is depicted. However, the configuration of the other portions is not particularly limited, and a known structure can be employed as a tire mold.

In the tire mold of an embodiment of the present technology, a molding surface 30A of the side plate 30 for forming the sidewall portion 2 of the tire includes a marking forming portion 31 corresponding to the marking portion 21 and a background forming portion 32 corresponding to the background portion 22, and the marking forming portion 31 is projected more than the background forming portion 32. Then, the marking forming portion 31 is processed into a shape corresponding to the serration 10. The tire according to an embodiment of the present technology can be molded by vulcanizing a tire in an unvulcanized state with the tire mold including the side plate 30 having the molding surface 30A having a shape corresponding to the marking portion 21, the background portion 22, and the serration 10 as described above.

A processing method of the above-described tire mold is not particularly limited. However, for example, the molding surface 30A having a desired shape can be processed by using a double angular cutter 40 as illustrated in FIG. 11 or a dovetail groove cutter (not illustrated).

### EXAMPLES

Tires of a Comparative Example and Examples 1 to 12 were manufactured. The tires include a marking portion and a background portion surrounding the marking portion in a sidewall portion and a serration including a plurality of ridges arranged side by side formed in the marking portion. In the tires, the shape of the ridge was variously changed.

Each ridge of the Comparative Example has, in a cross section orthogonal to the length direction of the ridge, first and second sidewall surfaces having a positive gradient with respect to a normal line of a reference plane on which the ridge is formed and a top surface parallel to the reference plane and has a cross-sectional shape forming a trapezoid. Each ridge of the Examples 1 to 12 has, in a cross section orthogonal to the length direction of the ridge, first and second sidewall surfaces having 0° or a negative gradient with respect to the normal line of the reference plane on which the ridge is formed, a first top surface inclined to one side with respect to the reference plane, and a second top surface inclined to the other side with respect to the reference plane. The first top surface and the second top surface are connected to each other, form a recess, and have a cross-sectional shape forming an M-shape. In the Comparative Example and the Examples 1 to 12, the angle α of the sidewall surface of the ridge, the apex angle β of the ridge, the pitch P of the ridge, the height H of the ridge, and the shape of the bottom surface between the ridges were set as shown in Table 1.

The visibility of these test tires was evaluated by the following test methods, and the results are shown in Table 1.

### Visibility:

Twenty testers visually observed the sidewall portion of each test tire from various angles, confirmed the marking portion distinguished from the background portion due to absorption or reflection of light, and evaluated the visibility of the marking portion. The evaluation was carried out on a 5-point scale, with the Comparative example being given a score of 3 points. Evaluation results are expressed as index values based on the sum of the evaluation points of the twenty testers, with the Comparative Example being assigned an index value of 100. Larger index values indicate superior visibility.

TABLE 1-1

| | Comparative | Example | Example | Example |
|---|---|---|---|---|
| | Example | 1 | 2 | 3 |
| Cross-sectional shape of ridge | Trapezoid | M-shape | M-shape | M-shape |
| Angle α of sidewall surface of | +15 | 0 | −5 | −5 |
| ridge (°) | | | | |
| Apex angle β of ridge (°) | 105 | 60 | 60 | 60 |
| Pitch of ridge P (mm) | 0.6 | 0.6 | 0.7 | 0.9 |
| Height of ridge H (mm) | 0.3 | 0.3 | 0.2 | 0.3 |
| Shape of bottom surface | Flat | Flat | Flat | V-shape |
| between ridges | | | | |
| Visibility (index value) | 100 | 105 | 115 | 125 |

TABLE 1-2

| | Example | Example | Example | Example | Example |
|---|---|---|---|---|---|
| | 4 | 5 | 6 | 7 | 8 |
| Cross-sectional shape of ridge | M-shape | M-shape | M-shape | M-shape | M-shape |
| Angle α of sidewall surface of | −10 | −10 | −5 | −5 | −10 |
| ridge (°) | | | | | |
| Apex angle β of ridge (°) | 60 | 60 | 45 | 45 | 45 |
| Pitch of ridge P (mm) | 0.6 | 1.0 | 0.6 | 0.55 | 0.6 |
| Height of ridge H (mm) | 0.25 | 0.3 | 0.3 | 0.4 | 0.25 |
| Shape of bottom surface | Flat | V-shape | Flat | V-shape | Flat |
| between ridges | | | | | |
| Visibility (index value) | 115 | 125 | 120 | 130 | 125 |

TABLE 1-3

| | Example | Example | Example | Example |
|---|---|---|---|---|
| | 9 | 10 | 11 | 12 |
| Cross-sectional shape of ridge | M-shape | M-shape | M-shape | M-shape |
| Angle α of sidewall surface of | −10 | −15 | −5 | −10 |
| ridge (°) | | | | |
| Apex angle β of ridge (°) | 45 | 45 | 30 | 30 |
| Pitch of ridge P (mm) | 0.55 | 0.55 | 0.55 | 0.6 |
| Height of ridge H (mm) | 0.3 | 0.25 | 0.25 | 0.25 |
| Shape of bottom surface | V-shape | V-shape | Flat | Flat |
| between ridges | | | | |
| Visibility (index value) | 130 | 130 | 125 | 125 |

As can be seen from Table 1, the tires of Examples 1 to 12 had excellent visibility compared with that of the Comparative Example.

1. A tire, comprising: in a sidewall portion, a marking portion and a background portion surrounding the marking portion; and a serration formed in any one of the marking portion and the background portion, the serration including a plurality of ridges arranged side by side;
each ridge of the ridges having, in a cross section orthogonal to a length direction of the ridge, a first and a second sidewall surfaces having 0° or a negative gradient with respect to a normal line of a reference plane on which the ridge is formed, a first top surface inclined to one side with respect to the reference plane, and a second top surface inclined to the other side with respect to the reference plane, and
the first top surface and the second top surface being connected to each other and forming a recess.

2. The tire according to claim 1, wherein each ridge has a symmetrical shape in the cross section orthogonal to the length direction of the ridge.

3. The tire according to claim 1, wherein angles α of the first and the second sidewall surfaces with respect to the normal line of the reference plane are each in a range −25°≤α<0°.

4. The tire according to claim 1, wherein an apex angle β of the ridge in the cross section orthogonal to the length direction of the ridge is in a range 30°≤β≤60°.

5. The tire according to claim 1, wherein a pitch of the ridge ranges from 0.5 mm to 1.2 mm, and a height of the ridge ranges from 0.2 mm to 0.5 mm.

6. The tire according to claim 1, wherein:
a gap between the ridges adjacent to each other is wider toward a side of the reference plane of the ridges; and
a bottom surface between the ridges adjacent to each other has a flat shape or a V-shape in the cross section orthogonal to the length direction of the ridge.

7. The tire according to claim 1, wherein the ridge includes a chamfered portion composed of a flat surface or a curved surface between the first top surface and the first sidewall surface and between the second top surface and the second sidewall surface.

8. A tire mold for molding the tire according to claim 1, the tire mold comprising a molding surface having a shape corresponding to the marking portion, the background portion, and the serration.

9. The tire according to claim 2, wherein angles α of the first and the second sidewall surfaces with respect to the normal line of the reference plane are each in a range −25°≤α<0°.

10. The tire according to claim 9, wherein an apex angle β of the ridge in the cross section orthogonal to the length direction of the ridge is in a range 30°≤β≤60°.

11. The tire according to claim 10, wherein a pitch of the ridge ranges from 0.5 mm to 1.2 mm, and a height of the ridge ranges from 0.2 mm to 0.5 mm.

12. The tire according to claim 11, wherein:
a gap between the ridges adjacent to each other is wider toward a side of the reference plane of the ridges; and
a bottom surface between the ridges adjacent to each other has a flat shape or a V-shape in the cross section orthogonal to the length direction of the ridge.

13. The tire according to claim 12, wherein the ridge includes a chamfered portion composed of a flat surface or a curved surface between the first top surface and the first sidewall surface and between the second top surface and the second sidewall surface.

14. A tire mold for molding the tire according to claim 13, the tire mold comprising a molding surface having a shape corresponding to the marking portion, the background portion, and the serration.
